(19) United States
(12) Patent Application Publication
(10) Pub. No.: US 2017/0280860 A1
(43) Pub. Date: Oct. 5, 2017

(54) Apparatus constructed of rubber type material and/or solid type material and/or any elastic material to secure inserted objects of any material and/or shape and/or dimension and/or size and maintain a water tight seal from immediately after point of entry to end and rubber material and/or elastic material countermeasure provides water tight seal and suspended support and vibration absorption and shock absorption and rotational tolerance and support

(71) Applicant: Michael Anthony Di Monte, SR., Cream Ridge, NJ (US)

(72) Inventor: Michael Anthony Di Monte, SR., Cream Ridge, NJ (US)

(21) Appl. No.: 14/995,209

(22) Filed: Mar. 29, 2016

(51) Int. Cl. A45F 5/00; F16M 13/02

(52) U.S. Cl. CPC A45F 5/00; F16M 13/02; A45F 2200/0566; A45F 2200/0575

(57) ABSTRACT

An object-holding apparatus comprising a body having at least one cavity formed on said one surface. The cavity further comprises a pathway extending from the surface into the body. At least one object can be disposed into the pathway of the cavity and be held tightly in the pathway. The object-holding apparatus can be water-tight with a tube filled with a flexible filling material being inserted into the pathway of the cavity of the body of the object-holding apparatus. The object to be held in the pathway can include but not limited to tools such as drill bits, impact driver bits, other oversized or small tool accessories, other tools including but not limited to screwdrivers, pliers, as well as any other item which a user would like to hold securely. A method to make an object-holding apparatus is also presented.

### CROSS-REFERENCE RELATED TO RELATED APPLICATIONS

Not Available

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

A wide variety of pouches, cases or other such holders, containers or carriers have been devised for holding and organizing objects, tools, tool accessories or other large and small articles.

Carriers have been used during transport and or worn and or stored and have been used for many years. Typically the fit of the object within most carriers have always been a loose fit with some other's providing a more snug fit.

A problem with carriers is that they are usually of a fixed size. They do not provide a watertight seal. If you want to use them, to hold or carry an object or other container that doesn't fit snugly in the carrier, it tends to move around and spill its contents if turned sideways or upside-down. Also, it's not unusual to find an oddly shaped object or other container that you like to carry with you doesn't fit in the carrier at all or is very loose and clumsy. An example is a hex key or a pair of scissors or a drill bit and even a light bulb. In other cases, the carrier is too shallow and the container easily falls out of the carrier and onto the floor, onto another person in close proximity, or even the head of a person below. It can also fall out when a vehicle turns, drives over a bump, or other sudden movements.

For these reasons users of carriers are disappointed in carriers available today for not protecting, holding, storing and containing objects properly while in use, carrying or being transported. This results in loosing objects, wasting time, financial loss to replace lost or damaged objects, property damage due to objects falling out while being worn or carried requiring expensive repairs, and even injury when objects fall out and injure a person.

### BRIEF SUMMARY OF THE INVENTION

This Brief Summary is included so as to introduce, in an abbreviated form, various topics to be elaborated upon below in the Detailed Description. This Brief Summary is not intended to identify key or essential aspects of the claimed invention. This brief Summary is similarly not intended for use as an aid in determining the scope of the claims.

The subject matters of this application overcomes the aforementioned problems and may be used as a watertight secure carrier regardless of the objects shapes, widths and depths. The invention is directed to an object-holding apparatus. It comprises: a body having at least one surface, wherein at least one cavity is formed on the one surface, wherein the cavity further comprises a pathway, wherein the pathway extends from the one surface into the body, wherein at least one object can be disposed into the cavity, wherein the pathway can receive the object, wherein the object has a longitudinal length, wherein the object can be disposed along the longitudinal length of the object into the cavity, wherein the pathway is formed by a wall and a bottom, wherein the pathway has a longitudinal length, wherein the pathway extends along the longitudinal length of the pathway inwardly to the body, wherein the wall is substantially contacted with the object to secure the object in the cavity when the object is disposed in the cavity.

The present invention also is directed to an object-holding apparatus, which comprises: a body having at least one surface, wherein at least one cavity is formed on the one surface, wherein the cavity comprises a pathway, wherein the pathway extends from the one surface into the body, wherein the pathway has a longitudinal length, wherein the pathway has at least one cross section perpendicular to the longitudinal length of the pathway, and wherein the cross section has a diameter; at least one internal ring, wherein the internal ring is flexible, Wherein the internal ring has an outer-diameter and an inner-diameter, and wherein the outer-diameter of the internal ring is substantially equal to the diameter of the cross section of the pathway; at least one tube, wherein the tube further comprises a tube wall and a bottom connected to the wall, wherein the tube has a longitudinal length equal or less than the longitudinal length of the pathway of the cavity, wherein the tube has a cross section perpendicular to the longitudinal length of the tube, wherein the cross section of the tube is substantially equal to an area formed by the inner-diameter of the internal ring, wherein the tube wall is attached to the inner-diameter of the internal ring, and wherein the tube is disposed in the pathway of the cavity; at least one filling material, wherein the filling material is flexible that has about Shore Hardness about 30 A to Shore Hardness about 40 A, wherein the filling material is disposed in the tube, and wherein the object can be disposed and inserted into the filling material.

The invention is also directed to a method to make an object holding apparatus to hold at least one object, which comprises: drilling at least a plurality of cavities on a surface of a deformable body of the object holding apparatus, extending a pathway of each plurality of cavities into the deformable body of the object holding apparatus in an angle about 0 degree to about 90 degree to a perpendicular axis of the one surface, wherein the pathway has a cross section less than a cross section of the object.

### BRIEF DESCRIPTION OF THE DRAWINGS

It should be understood that the drawings are merely representative, are not necessarily drawn to scale, and are not intended to limit the subject matter of this application.

FIG. 1 is a perspective view of one embodiment of the object holding apparatus.

FIG. 2 is an perspective view of one embodiment of the internal ring and the tube and the filling material of the object holding apparatus.

FIG. 3 FIG. 2 is an perspective view of one embodiment of the internal ring of the object holding apparatus.

FIG. 4 is a perspective view of one embodiment of the object holding apparatus with the tube inserted in the cavity.

### DETAILED DESCRIPTION

Before the present invention is described in greater detail, it is to be understood that this invention is not limited to particular embodiments described, and as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Other than in the embodiment or example, or where indicated otherwise, all numbers indicating ingredient quantities and/or reaction conditions are to be understood as being modified in every instance by the word “about,” which means the ingredient quantities or reaction conditions are within 10 percent to 15 percent of the indicated value.

Unless defined otherwise, all terms used herein have the same meaning as commonly understood by one of ordinary skill in the art to which this invention belongs. Although any methods and materials similar or equivalent to those described herein can be used in the practice or testing of the present invention, some potential and exemplary methods and materials may now be described. Any and all publications mentioned herein are incorporated herein by reference to disclose and describe the methods and/or materials in connection with which the publications are cited. It is understood that the present disclosure supersedes any disclosure of an incorporated publication to the extent there is a contradiction.

It must be noted that as used herein and in the appended claims, the singular forms “a”, “an”, and “the” may also include the plural referents unless the context clearly dictates otherwise.

It is further noted that the claims may be drafted to exclude any element that may be optional. As such, this statement is intended to serve as antecedent basis for use of such exclusive terminology as “solely”, “only” and the like in connection with the recitation of claim elements, or the use of a “negative” limitation.

As will be apparent to those of skill in the art upon reading this disclosure, each of the individual embodiments described and illustrated herein has discrete components and features, which may be readily separated from or combined with the features of any of the other several embodiments without departing from the scope or spirit of the present invention.

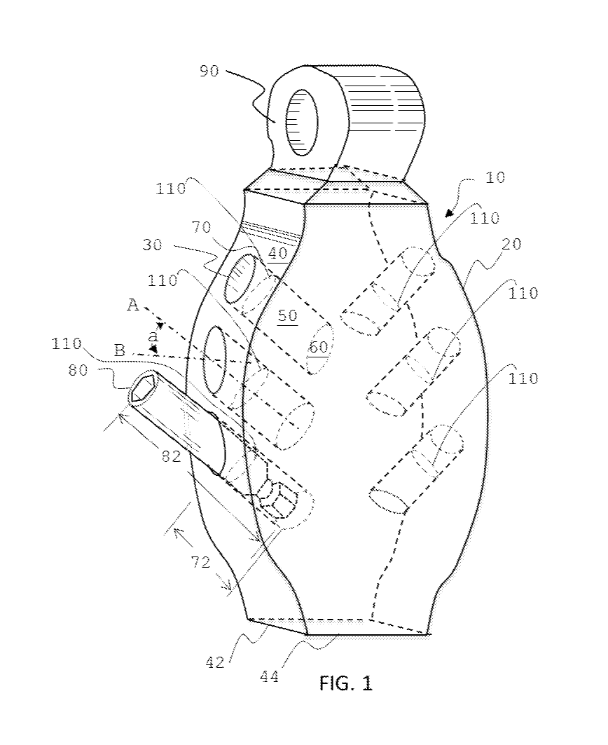

Referring to FIG. 1, one of the embodiments of an object-holding apparatus 10 has a body 20. The body 20 has at least one surface 40. At least one cavity 30 is formed on the surface 40. The cavity 30 comprises a pathway 70, which extends from surface 40 inwardly into the body 20. The pathway 70 comprises a wall 50 and a bottom 60. The pathway 70 of cavity 30 can receive an object 80, such as but not limited to drive bits, drill bits, impact drill bits, small tool, or oversized tools. The pathway 70 has a longitudinal length 72 downwardly into body 20. The angle a is between the longitudinal axis A of pathway 70 and the perpendicular axis B of the surface 40. The angle a can be ranged from about 0 degree to about 90 degree. The object 80 can be disposed along the longitudinal length 82 of object 80 into the cavity 30. The object 80 has a longitudinal length 82 greater than a longitudinal length 72 of the pathway 70. Therefore, a portion of the object 80 extends above the surface 40 of the body 20 when the object 80 is disposed in the cavity 30. A wall 50 of the pathway 70 is tightly contacted with object 80 and exerts a pressure on object 80 to secure the object 80 in the cavity 30.

One embodiment of the body 20 can be made of deformable materials that has a Shore Hardness between about 75 A and about 85 A, such as rubber or semi-rigid plastic. When the body 20 has more than one surface 40 such as in long shape, the short side 42 has a surface 40 and long side 44 has a surface 40. The cavity 30 is form on surface 40 of short side 42. The pathway 70 extends from surface 40 of short side 42 into said body 20. The object holding apparatus 10 can have optional hanger 90 for hanging the object holding apparatus 10.

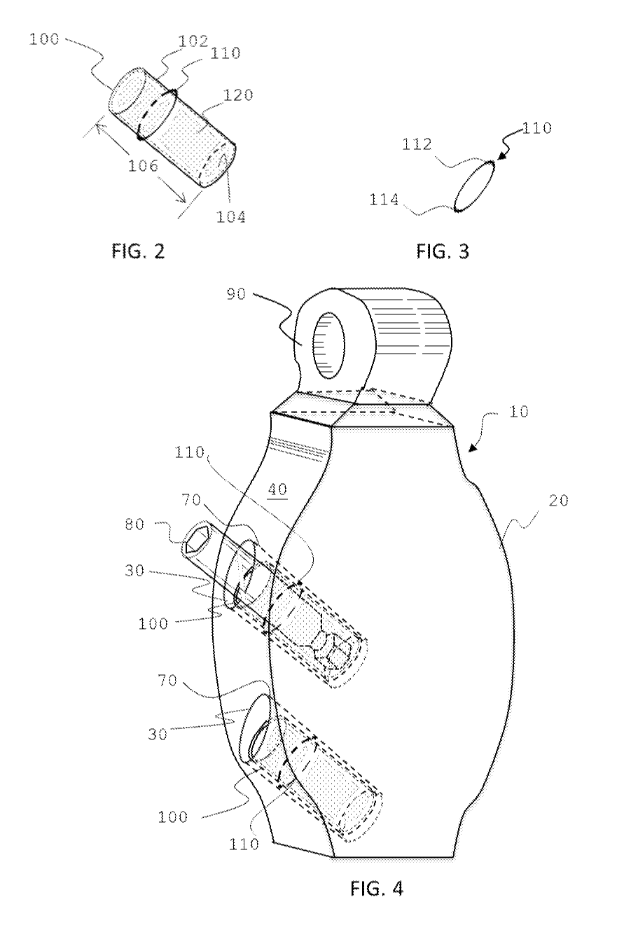

Referring to FIG. 2 and FIG. 3, one embodiment of a tube 100 having internal ring 110. The tube 100 has a tube wall 102 and a bottom 104. The tube 100 has a longitudinal length 106 less than the longitude length 72 of pathway 70. The tube 100 can be filled with filling material 120 that is flexible and has a Shore Hardness about 30 A to Shore Hardness about 40 A. The cross section of tube 100 is substantially equal to an area formed by said inner-diameter 112 of the internal ring 110.

Referring to FIG. 3, one embodiment of the internal ring 110 has an inner diameter 112 and outer diameter 114. The inner-diameter 112 is equal to the cross section of the tube 100 and the outer-diameter 112 is substantially equal to the cross section of the pathway 70 of the cavity 30 on one surface 40. The tube 100 has a longitudinal length 106 equal or less than said longitudinal length 72 of said pathway 70 of said cavity.

Referring to FIG. 4, the tube 100 filled with filling material 120 with the internal ring 110 is inserted into the pathway 70 of the cavity 30 in the body 20. The object 80 is disposed in the tube 100 and inserted into the filling material 120. Also referring to FIG. 4, one embodiment of the object holding apparatus 10 can have a hanger 90.

1. An object-holding apparatus comprising:
a body having at least one surface,
wherein at least one cavity is formed on said one surface, wherein said cavity further comprises a pathway,
wherein said pathway extends from said one surface into said body,
wherein at least one object can be disposed into said cavity,
wherein said pathway can receive said object,
wherein said object has a longitudinal length,
wherein said object can be disposed along said longitudinal length of said object into said cavity,
wherein said pathway is formed by a wall and a bottom, wherein said pathway has a longitudinal length,
wherein said pathway extends along said longitudinal length of said pathway into said body, and
wherein said wall is substantially contacted with said object to secure said object in said cavity when said object is disposed in said cavity.

2. The object-holding apparatus of claim 1,
wherein said longitudinal length of said object is greater than said longitudinal of said pathway, and
wherein a portion of said object extends above said one surface of said body when said object is disposed in said cavity.

3. The object-holding apparatus of claim 1,
wherein said body is deformable,
wherein said pathway has at least one cross section perpendicular to said longitudinal length of said pathway,
wherein said object has at least one cross section perpendicular to said longitudinal length of said pathway,
wherein said cross section of said pathway is less than said cross section of said object to cause said wall of said pathway tightly contacting with said object, and
wherein an exertion of pressure is between said wall of said pathway and said object.

4. The object-holding apparatus of claim 1, wherein said body is made of at least one deformable material that has a Shore Hardness between about 75 A and about 85 A.

5. The object-holding apparatus of claim 1, wherein said pathway extends along said longitudinal length downwardly into said body to form an angle between about 0 degree to about 90 degree with a perpendicular axis of said one surface.

6. The object-holding apparatus of claim 1,
wherein said body is a long shape having at least one long side and at least one short side,
wherein said short side has a surface,
wherein said long side has a surface,
wherein said cavity is formed on said one surface on said long side, and
wherein said pathway extends along said longitudinal length downwardly into said body to form an angle between about 0 to about 90 degree with said one surface on short side.

7. The object-holding apparatus of claim 1,
wherein said body is a long shape having at least one long side and at least one short side,
wherein said short side has a surface,
wherein said long side has a surface,
wherein said cavity is formed on said one surface on said short side, and
wherein said pathway extends from said one surface of said short side along said longitudinal length of said pathway downwardly into said body to form an angle about 0 degree to about 90 degree relative to perpendicular axis of said one surface on long side.

8. An object-holding apparatus, comprising:
a body having at least one surface, wherein at least one cavity is formed on said one surface, wherein said cavity comprises a pathway, wherein said pathway extends from said one surface into said body, wherein said pathway has a longitudinal length, wherein said pathway has at least one cross section perpendicular to said longitudinal length of said pathway, and wherein said cross section has a diameter;
at least one internal ring, wherein said internal ring is flexible, wherein said internal ring has an outer-diameter and an inner-diameter, and wherein said outer-diameter of said internal ring is substantially equal to said diameter of said cross section of said pathway, and
wherein said internal ring is disposed in said pathway of said cavity.

9. The object-holding apparatus of claim 8, wherein said pathway is configured with an angle between about 0 to about 90 degree with a perpendicular axis of said one surface.

10. The object-holding apparatus of claim 8, wherein water cannot enter into said tube when said object is disposed in said tube.

11. A method to make an object holding apparatus to hold at least one object, comprising:
Drilling at least a plurality of cavities on a surface of a deformable body of said object holding apparatus,
Extending a pathway of each said plurality of cavities into said deformable body of said object holding apparatus in an angle about 0 degree to about 90 degree to a perpendicular axis of said one surface, wherein said pathway has a cross section less than a cross section of said object.

12. The method to make an object holding apparatus to hold at least one object of claim 11, wherein said body is made of deformable material that has a Shore Hardness between about 75 A and about 85 A.

13. The method to make an object holding apparatus to hold at least one object of claim 11, further comprising:
Inserting each of a plurality of tubes into at least an internal ring, wherein each of said plurality of tubes comprises a tube wall and a bottom, wherein said internal ring is made of deformable material,
Inserting each of said plurality of tubes into each of said plurality of cavities, and
Filing at least one filling material into each of said plurality of tubes.

14. The method to make an object holding apparatus to hold at least one object of claim 13, wherein said filling material is flexible that has about Shore Hardness about 30 A to Shore Hardness about 40 A.

15. The object-holding apparatus of claim 1, further comprising:
at least one internal ring, wherein said internal ring is flexible, wherein said internal ring has an outer-diameter and an inner-diameter, wherein said outer-diameter of said internal ring is substantially equal to said diameter of said cross section of said pathway, and wherein said internal ring is disposed inside said pathway.

16. The object-holding apparatus of claim 1, further comprising:
at least one internal ring, wherein said internal ring is flexible, wherein said internal ring has an outer-diameter and an inner-diameter, wherein said outer-diameter of said internal ring is substantially equal to said diameter of said cross section of said pathway, and wherein said internal ring is disposed inside said pathway;
at least one tube, wherein said tube further comprises a tube wall and a bottom connected to said wall, wherein said tube has a longitudinal length equal or less than said longitudinal length of said pathway of said cavity, wherein said tube has a cross section perpendicular to said longitudinal length of said tube, wherein said cross section of said tube is substantially equal to an area formed by said inner-diameter of said internal ring, wherein said tube wall is attached to said inner-diameter of said internal ring, and wherein said tube internal ring is disposed in said pathway of said cavity; and
at least one filling material, wherein said filling material is flexible that has about Shore Hardness about 30 A to Shore Hardness about 40 A, wherein said filling material is disposed in said tube, and wherein said object can be disposed in said tube and inserted into said filling material.
